(19) United States
(12) Patent Application Publication
(10) Pub. No.: US 2023/0173523 A1
(43) Pub. Date: Jun. 8, 2023

(54) MASK AND AIR PRESSURE CONTROL SYSTEMS FOR USE IN COATING DEPOSITION

(71) Applicant: PRC-Desoto International, Inc., Sylmar, CA (US)

(72) Inventors: Yong Han Yeong, Valley Village, CA (US); Mehran Arbab, Chicago, IL (US); Adam Colbourne, Cambridgeshire (GB); Jonny Waite, Cambridgeshire (GB); Henry Rolt, Cambridgeshire (GB); Simon Kew, Cambridgeshire (GB); Alan Hudd, Cambridgeshire (GB)

(73) Assignee: PRC-Desoto International, Inc., Sylmar, CA (US)

(21) Appl. No.: 17/997,937

(22) PCT Filed: May 7, 2021
(86) PCT No.: PCT/US2021/031413

§ 371 Date: Nov. 4, 2022

Related U.S. Application Data
(60) Provisional application No. 63/021,838, filed on May 8, 2020.

(51) Int. Cl. B05B 12/22; B05B 14/00

(52) U.S. Cl. CPC B05B 12/22; B05B 14/00

(57) ABSTRACT

A mask and air pressure control system for use in coating deposition is disclosed. A method is provided for controlling liquid coating droplets during deposition onto a substrate by directing atomized liquid coating droplets in a flow path toward the substrate, and applying a vacuum or pressurized air from an air pressure control system to at least a portion of the atomized liquid coating droplets in the flow path. The air pressure control mask comprises an air pressure control fixture structured and arranged for connection to a source of vacuum or pressurized air, and a nozzle opening structured and arranged to at least partially surround a flow path of the liquid coating droplets and to selectively allow at least a portion of the liquid coating droplets to pass through the air pressure control mask, wherein the vacuum or pressurized air prevents at least a portion of oversprayed liquid coating droplets from being deposited on the substrate outside an intended edge of the coating.

### CROSS-REFERENCE TO RELATED APPLICATION

This application claims the benefit of U.S. Provisional Patent Application Ser. No. 63/021,838 filed May 8, 2020, which is incorporated herein by reference.

### FIELD OF THE INVENTION

The present invention relates to mask and air pressure control systems for coating deposition devices.

### BACKGROUND INFORMATION

Coating deposition systems have been used to apply coatings onto various substrates. The systems include droplet generating devices including mass resonators, piezoelectric elements, wave concentrators and fluid ejectors. In such systems, it is desirable to achieve good edge sharpness.

### SUMMARY OF THE INVENTION

The present invention provides a method for controlling liquid coating droplets during deposition onto a substrate. The method comprises directing atomized liquid coating droplets in a flow path toward the substrate, and applying a vacuum or pressurized air to at least a portion of the atomized liquid coating droplets in the flow path.

The present invention also provides an air pressure control mask for depositing liquid coating droplets on a substrate to produce a coating. The air pressure control mask comprises an air pressure control fixture structured and arranged for connection to a source of vacuum or pressurized air, and a nozzle opening structured and arranged to at least partially surround a flow path of the liquid coating droplets and to selectively allow at least a portion of the liquid coating droplets to pass through the air pressure control mask. The vacuum or pressurized air prevents at least a portion of oversprayed liquid coating droplets from being deposited on the substrate outside an intended edge of the coating.

### BRIEF DESCRIPTION OF THE DRAWINGS

FIG. 1 is a partially schematic isometric view of an air pressure control mask of the present invention and a coating droplet ejector positioned above the mask.

FIG. 2 a partially schematic isometric view of the air pressure control mask of FIG. 1.

FIG. 3 is a top view of the air pressure control mask of FIG. 1.

FIG. 4 is a side sectional view taken through section 4-4 of FIG. 3.

FIG. 5 is a partially schematic side sectional view of the air pressure control mask similar to that shown in FIG. 4 positioned above a substrate to be coated and below a coating droplet ejector, illustrating the flight of coating droplets from the ejector to the substrate through a central nozzle orifice of the mask and application of vacuum to remove a portion of the droplets in flight to improve edge sharpness.

FIG. 6 is a bottom view of the air pressure control mask of FIG. 1.

FIG. 7 is a magnified portion of FIG. 6, illustrating the central nozzle opening of the mask and the coating droplet ejector located above the opening.

FIG. 8 is an isometric view of a coating droplet ejector.

FIG. 9 is a bottom view of the coating droplet ejector of FIG. 8.

FIG. 10 illustrates a coating droplet ejector including an air delivery tube for delivering air bursts to clean the ejector during use.

FIG. 11 illustrates a shutter system that can be used to open and close a mask nozzle opening.

FIG. 12 illustrates variable painting speeds that may be used to deposit coatings with a mask and air pressure control system of the present invention, which may include a shutter system as shown in FIG. 11.

FIG. 13 illustrates a deposited coating pattern including a bulk deposition portion in internal regions, and fine deposition edges, both of which may be produced with a mask and air pressure control system of the present invention.

FIG. 14 is a schematic side view of an air pressure control mask with an adjustable nozzle opening and multiple vacuum suction ports at different locations.

FIG. 15 illustrates the use of a coating droplet ejector to deposit a coating without the use of a mask and air pressure control system.

FIG. 16 is a photograph of an edge of a sprayed coating showing oversprayed droplets deposited outside the edge of the coating.

FIG. 17 is a photograph of an edge of a sprayed coating showing fewer oversprayed droplets deposited outside the edge of the coating in comparison with the sprayed coating edge shown in FIG. 16.

FIG. 18 is a graph of number of oversprayed droplets versus oversprayed droplet feret diameters including an upper trace generated from the image of FIG. 16 that is used to establish empirically derived edge sharpness criteria, and a lower trace generated from the image of FIG. 17 that shows good edge sharpness characteristics within the criteria established by the upper trace of a coating produced with a mask and air pressure control system of the present invention.

FIGS. 19 and 20 are graphs of numbers of oversprayed droplets versus oversprayed droplet diameters illustrating linear and parabolic edge sharpness criteria, respectively.

FIG. 21 includes the photograph of FIG. 17 and a magnified portion thereof showing a peak to valley distance at the edge of the sprayed coating.

### DETAILED DESCRIPTION OF THE INVENTION

The present invention provides mask and air pressure control systems for coating deposition devices including coating droplet generation systems. As used herein, the term “air pressure control” includes the application of vacuum, i.e., sub-atmospheric pressures, and the application of air pressures above atmospheric pressure. The systems may include a coating droplet ejector that may be connected to a conventional mass resonator, piezoelectric elements and a conical wave concentrator. The mask and air pressure control systems include an air pressure control mask with a nozzle opening. The coating droplet ejector may be located above the nozzle opening.

The present system may be used to spray deposit various types of coatings, such as solvent-based and/or water-based aerospace coatings, automotive coatings, architectural coatings, and the like. For example, solvent-based polyurethane coatings typically used for coating aircraft may be applied with the present mask and pressure control systems.

The air pressure control mask applies a vacuum and/or pressurized air to the coating droplets in flight. For example, when a vacuum is applied, one or more suction ports may surround the nozzle opening of the mask to create sub-atmospheric or vacuum pressure around the perimeter of the nozzle opening in the region of droplet travel. The negative air pressure draws smaller coating droplets through the air suction ports, while allowing larger droplets to pass through the nozzle opening for deposition on a substrate. Removal of the smaller droplets reduces advection and unwanted overspray, and may also result in a narrower droplet size distribution of the larger droplets that are deposited on the substrate. Sharp painted edges may thus be formed by masking and shaping of deposition patterns by a non-contact air pressure control mask in the region where the coating droplets pass through the nozzle opening.

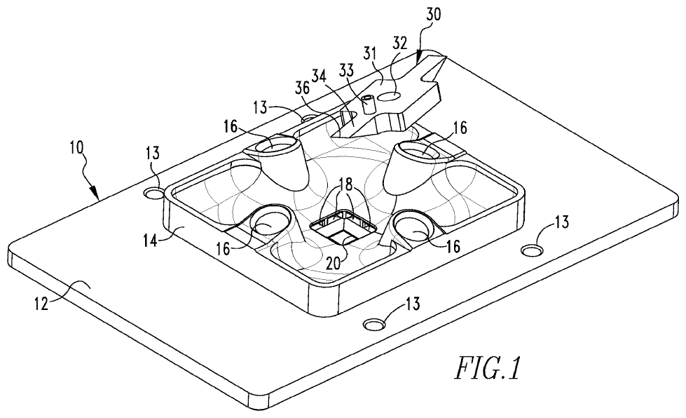

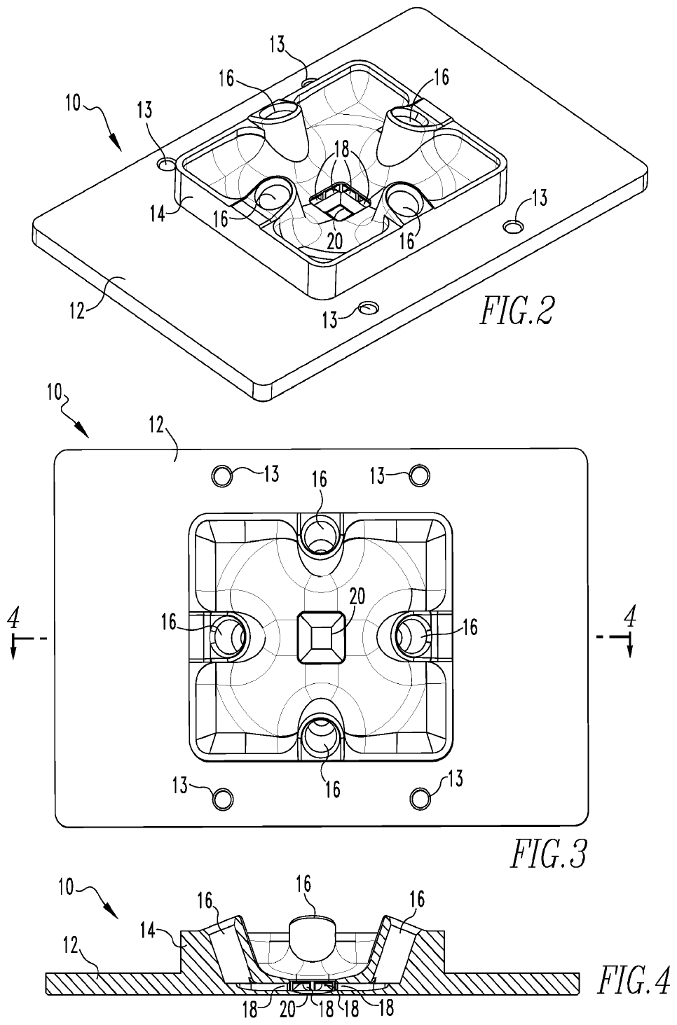

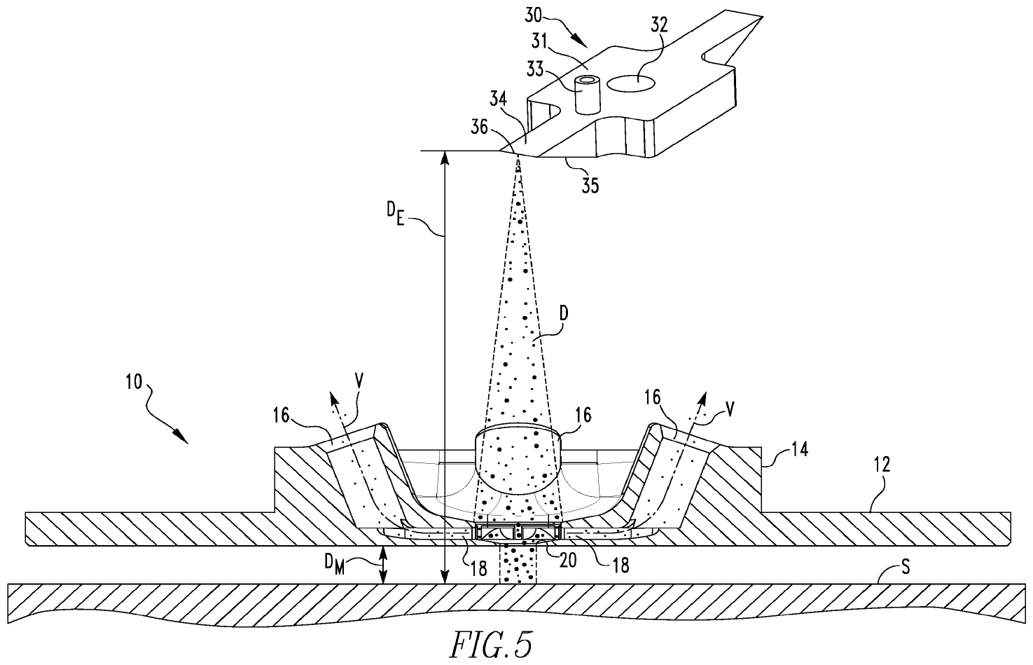

FIGS. 1-5 illustrate an air pressure control mask 10 of the present invention. The air pressure control mask 10 includes a base 12 with an air pressure control fixture 14 extending upwardly therefrom. The base 12 includes holes 13 that may be used to mount the air pressure control mask 10 on a standard printer fixture (not shown). The air pressure control fixture 14 includes multiple air pressure control ports 16 communicating with multiple air pressure control openings 18. A nozzle opening 20 is provided through the base 12 in a central portion of the air pressure control mask 10.

As shown in FIGS. 1 and 5-9, a coating droplet ejector 30 is positioned above the nozzle opening 20 of the air pressure control mask 10. The coating droplet ejector 30 includes an ejector base 31 with a mounting hole 32 for attachment to a conventional system including a mass resonator, piezoelectric element and wave concentrator, as more fully described below. A coating delivery port 33 extends upward from the base 31. An ejector arm 34 extending laterally from the base 31 has a generally planar lower surface 35 terminating in an ejector edge 36.

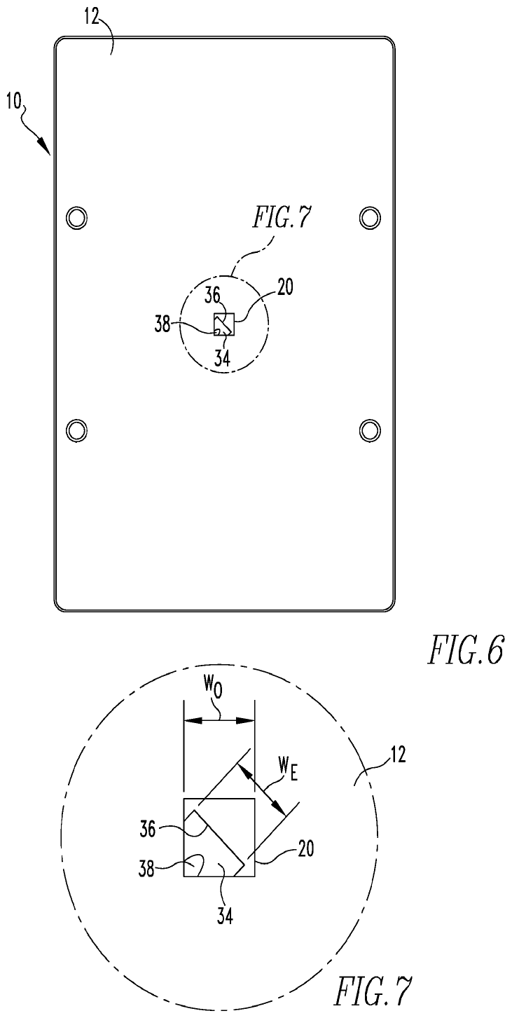

As shown most clearly in the bottom views of FIGS. 6, 7 and 9, the ejector arm 34 includes a fluid ejection orifice 38 through which paint and other coatings may be delivered. The ejector edge 36 of the ejector arm 34 is located vertically above the nozzle opening 20 of the air pressure control mask 10 at a 45° angle in relation to the edges of the square nozzle opening 20 of the pressure control mask 10. The nozzle opening 20 may be square as shown, rectangular, circular or the like. The ejector may be positioned directly above the nozzle opening 20, with the flat edge 36 of the ejector 30 positioned diagonally to the nozzle opening 20. The atomized coating droplets pass through the nozzle opening 20 for deposition on the substrate S.

As schematically shown in FIG. 5, the coating droplet ejector 30 is used to generate a coating droplet spray pattern D that is directed toward the nozzle opening 20 of the air pressure control mask 10. The droplet spray pattern D includes a particle size distribution including relatively small, medium and large coating droplets. The various droplet sizes shown in FIG. 5 are not drawn to scale, but are enlarged to more clearly illustrate the different droplet sizes in the spray pattern D. As more fully described below, when a vacuum is applied to the ports 16, relatively small droplets are drawn through the suction openings 18 and are entrained within a vacuum exhaust V. Conversely, if air at elevated pressure is delivered directed through the ports 16, such positive air flow may be used to direct smaller coating droplets inward within the perimeter of the coating edge.

As shown in FIG. 5, the ejector edge 36 of the coating droplet ejector 30 is located an ejector distance D_{E} from the top surface of the substrate S. A bottom surface of the base 12 of the air pressure control mask 10 is located a mask distance D_{M} above the upper surface of the substrate S. The ejector distance D_{E} may be adjusted as desired, and may typically range from 5 to 20 mm, or from 8 to 15 mm, or from 10 to 12 mm. The mask distance D_{M} may typically range from 0.5 to 8 mm, or from 1 to 5 mm, or from 2 to 3 or 4 mm. The ratio of D_{E}:D_{M} may typically range from 20:1 to 1:1, or from 10:1 to 2:1, or from 8:1 to 3:1.

Multiple coating droplet ejector 30 shapes and dimensions may be used, including wedge and anvil designs. The fluid coating is drawn to the flat ejector edge 36 closest to the fluid ejection orifice 38 via surface tension. The fluid is atomized and ejected at a single spot near the flat edge 36. The ejector 30 may be fabricated out of any suitable material such as polished titanium. The coating droplet ejector 30 provides minimal variance in ejection characteristics and clean operation. An ejector with multiple orifices may be used to eject higher volume of fluids.

As shown in FIG. 7, the nozzle opening 20 has a nozzle opening width W_{O}, which may typically range from 1 to 10 mm or more, for example, from 1.5 to 8 mm, or from 2 to 6 mm. The ejector edge 36 has an ejector edge width W_{E}, which may typically range from 0.5 to 10 mm, or from 1 to 5 mm, or from 1.5 to 4 mm. The ratio of W_{O}:W_{E} may typically range from 5:1 to 0.5:1, or from 2:1 to 0.8:1, or may be approximately 1:1.

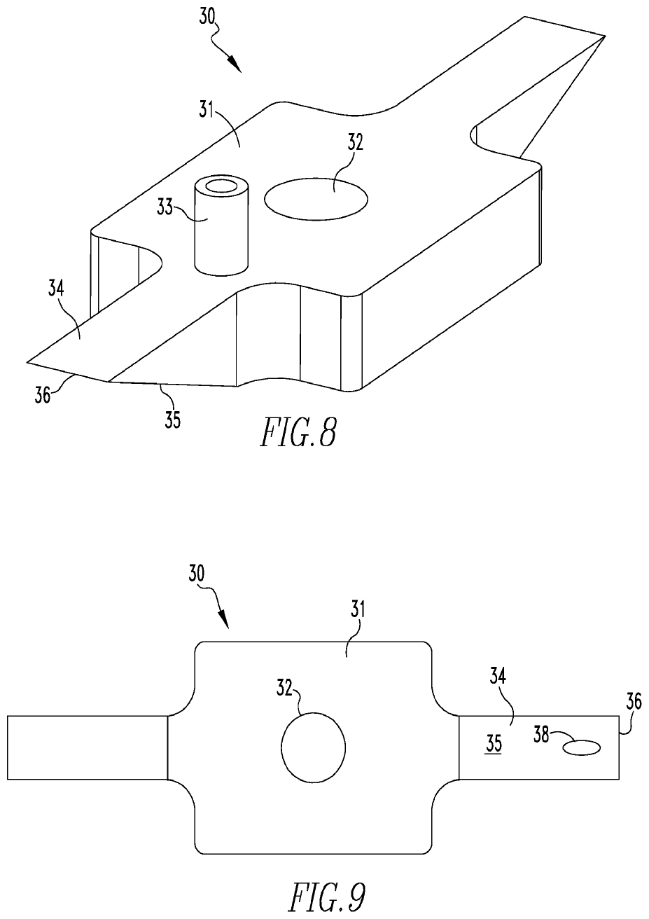

The coating droplet ejector may comprise a wedge design as shown in FIG. 15, or double anvil design as shown in FIGS. 8 and 9 with a single orifice 38, or may be a multiple-orifice design.

The mass resonator, piezoelectric elements and conical wave concentrator of the droplet generation system may be of any suitable design, such as disclosed in PCT Publication No. WO 2018/042165, which is incorporated herein by reference. Piezoelectric elements may be sandwiched between the mass resonator and wave concentrator. The coating droplet ejector 30 may be attached to the tip of the wave concentrator via the mounting hole 32. A temperature stabilization system (not shown) may be implemented to maintain the temperature of the resonating system at room temperature in order to stabilize the coating droplet ejection process.

The coating droplets may be precisely deposited on the substrate S resulting in sharp coating edges through mechanisms of: masking and shaping of the coating deposition pattern by the non-contact mask; and a negative or positive air pressure environment as the coating droplets pass through the nozzle opening 20. For example, four diaphragm pumps may individually generate negative air pressures within a range of from 0 to 55 kPa, or from 1 to 50 kPa, or from 2 to 40 kPa, in the region surrounding the nozzle opening 20 through the internal ports 16 and openings 18 of the mask 10. This negative air pressure may force smaller coating droplets, which are more susceptible to advection, to be drawn and removed through the openings 18 and ports 16. The smaller removed droplets may be collected, e.g., in a filter installed between the mask and diaphragm pumps (not shown). The larger droplets, which have more momentum and inertia, continue on their flight paths through the nozzle opening 20 to the substrate S. This mechanism may effectively reduce the coating droplet size distribution of the ejected droplets to minimize oversprayed droplets on the substrate S.

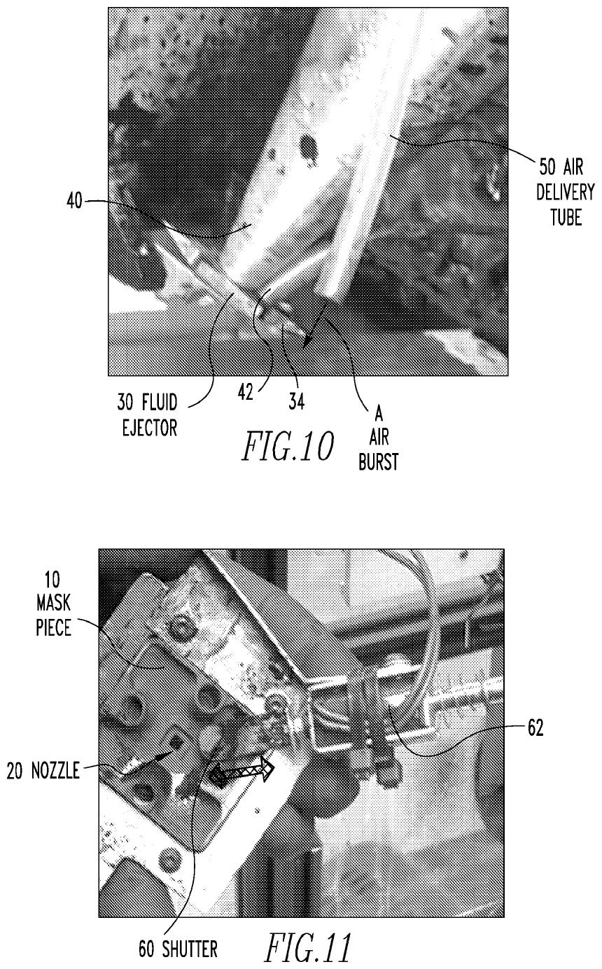

As shown in FIG. 10, the coating droplet ejector 30 is mounted on the tip of a wave concentrator 40 and a coating delivery tube 42 is connected to the coating delivery port on the ejector arm 34. A pressurized air delivery tube 50 has an outlet directed toward the ejector arm 34 to provide air bursts A that remove extra coating material from the ejector 30 and from the underlying mask in the region of the nozzle opening. An automated cleaning system may therefore be provided to release any coating remnants away from the ejector 30 and nozzle opening. With an automated cleaning system, continuous coating deposition operations for extended periods of time may be achieved. Therefore, intervals between depositions with a coating held in the system may not adversely affect coating quality.

Immediate start and stop of printing may be controlled via a shutter system. For example, as shown in FIG. 11, a reciprocating shutter 60 may be selectively retracted and extended over the nozzle opening 20 of the air pressure control mask 10 in order to allow or block the flow of coating droplets through the nozzle opening 20. A conventional solenoid valve 62 may be used to selectively retract and extend the shutter 60. Thus, when activated, the shutter 60 extends or retracts to open/close the nozzle opening 20. When fully extended, the shutter 60 may block the coating from being ejected from the nozzle opening 20, and the coating that is blocked may be removed from the mask 10 via the suction openings 18 and ports 16.

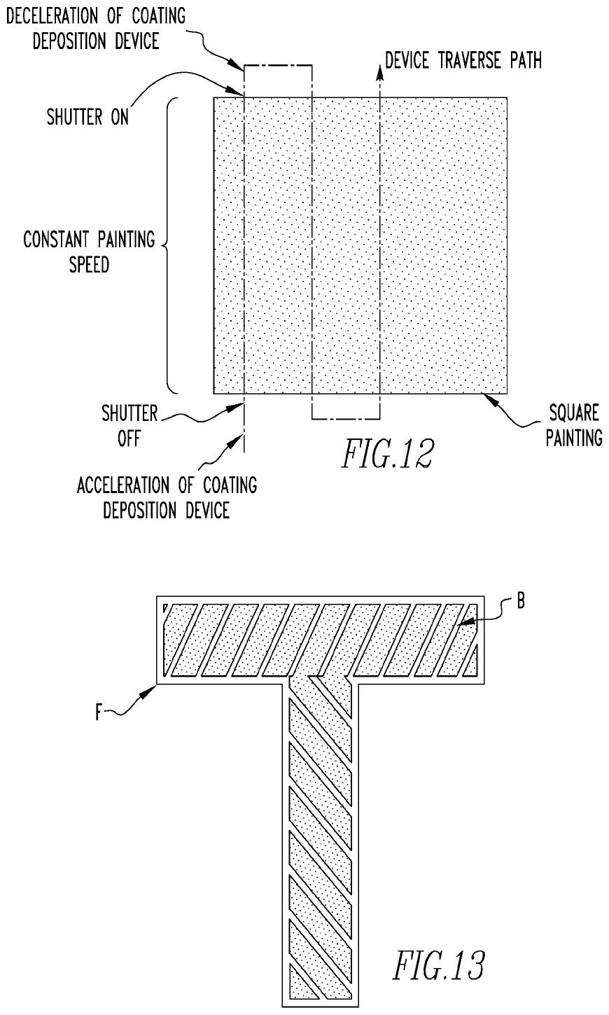

The on-off shutter 60 system may be integrated into the deposition process. For example, as shown in FIG. 12, the deposition device may traverse from a bottom of a square to the top in a “shutter-on” setting. At the point where the painting starts, the shutter 60 may be retracted and the coating is allowed to pass through the nozzle opening. The shutter 60 is extended once the nozzle opening is at top of the square. To maintain a painting of constant dry film thickness (DFT), the deposition device may accelerate at the beginning of the traverse path and prior to shutter off. Once the paint process is completed and the shutter 60 extended, the ejector 30 and mask 10 may decelerate, as schematically shown in FIG. 12. A coating of constant DFT may also be maintained by automatically adjusting the liquid coating flow rate supplied to the coating droplet ejector 30.

Multiple deposition modes may be used, e.g., a fine and a bulk deposition mode, with the fine deposition mode being performed at a slower rate than the bulk deposition mode. In the fine deposition mode, the mask with air pressure control system as previously described may be deployed. The deposition may typically be conducted at between 0.5 to 10 cm/s, for example, from 1 to 5 cm/s, or from 2 to 4 cm/s, to result in a sharp coated edge. In a bulk deposition mode, a different mask may be used. The nozzle of the bulk mask may be modified to be a circular in shape and measuring 6 mm in diameter. This allows for a larger amount of fluid to be deposited. As with the fine mask, pressure ports are present, e.g., to remove small droplets. The deposition speed for a bulk mode may be at least 10 cm/s, or at least 20 cm/s, or at least 30 cm/s, or up to 50 cm/s, or higher.

A coating deposition process may be conducted as schematically shown in FIG. 13. The painting of a shape in bulk deposition mode B followed by tracing of the shape edges in fine deposition mode F may achieve a balance of overall higher deposition rates and good coating edge sharpness in the fine painting mode F. In addition to changing deposition modes, a mask or masks with variable-sized and shaped nozzle openings may be used to paint shapes with sharp ends, e.g., the tip of a triangle, the orifice could be reduced to a minimum for detail painting. A variable mask nozzle opening may be implemented on a shutter system that is controlled to extend/retract to desired orifice opening sizes and shapes. The mechanism for extension/retraction can be driven by actuators, magnetics and memory shape alloys. For example, a shutter and solenoid system similar to that shown in FIG. 11 may be adapted to provide a variable sized or shaped nozzle opening.

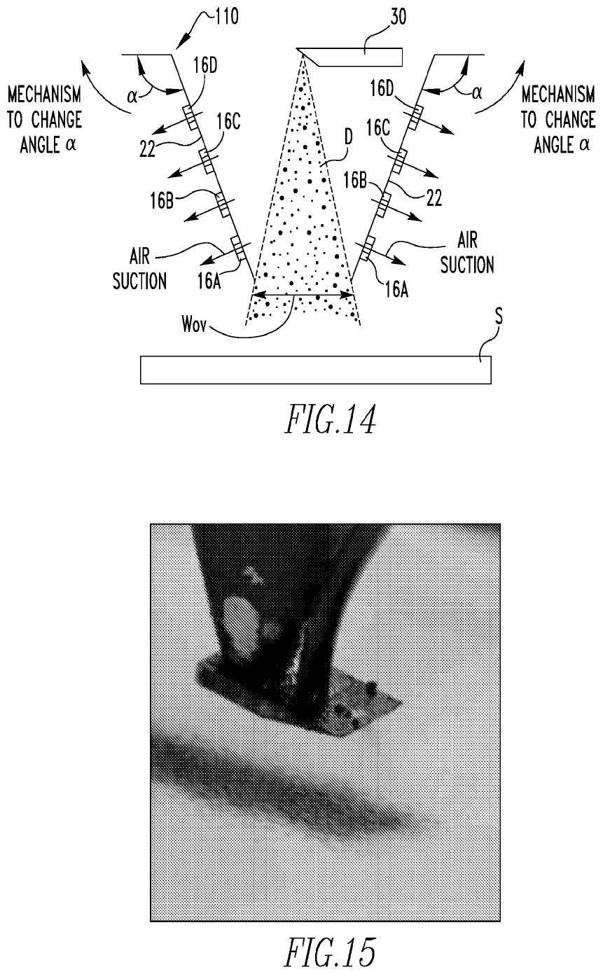

FIG. 14 schematically illustrates an air pressure control mask 110 including sidewalls 22 that can be adjusted to different angles α to provide a variable nozzle opening width W_{OV}. Opposing air pressure control or suction ports 16A, 16B, 16C and 16D are provided through the adjustable sidewalls 22, e.g., to selectively provide suction at different locations along the droplet spray pattern D generated by the coating droplet ejector 30. The nozzle opening size may thus be controlled by the angle α of the walls 22. In addition, air suction control can be provided through the walls to remove small, over-sprayed coating droplets.

Atomization and deposition of a coating from a wedge design fluid ejector are shown in FIG. 15. At resonant frequency, the deflections of the ejector provide sufficient energy to draw the fluid to the flat edge of the ejector for atomization. The energy provided to the atomized droplets is also sufficient to overcome the effects of gravity, thereby allowing for not only vertical prints, but also horizontal prints.

Conventional evaluation processes for sharp coated edges are currently qualitative. The present invention may utilize quantitative criteria to meet for a visually sharp coating edge viewed at 0.5 meters/˜20 inches away from the panel. These quantitative criteria may determine different grades of print sharpness for different applications.

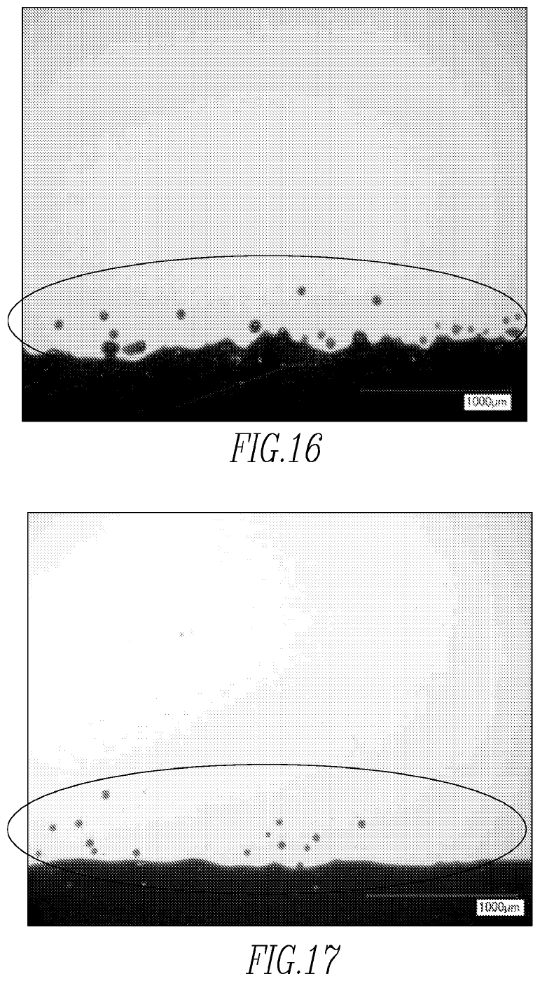

A microscopic image of a coating edge with a field of view of 3.5 mm×2.5 mm may be used. The feret diameter of oversprayed droplets, such as shown in the circled region in FIG. 16 of a sample image may be measured through standard image analysis.

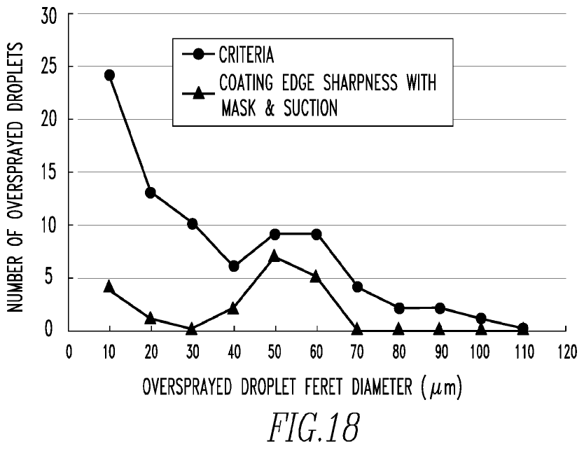

Coating edge sharpness using a mask and suction system of the present invention may achieve the results shown in FIG. 17. The coatings in FIGS. 16 and 17 are polyester base coatings commercially available from PPG Industries under the designation Desothane HD 9008. The black coatings are spray applied onto aluminum substrates that are pre-coated with a conventional HVLP spray gun with Desothane HD 9008 white coatings. The coating may have an average dry film thickness (DFT) of 1 mil (25 μm), ±0.15 mil (3.8 μm), gloss units above 90 at 60°, and tension values above 14. The sharpness may be evaluated using the quantitative criteria described below. FIG. 18 is a graph of number of oversprayed droplets versus oversprayed droplet feret diameters including an upper trace generated from the image of FIG. 16 that is used to establish empirically derived edge sharpness criteria, and a lower trace generated from the image of FIG. 17 that shows good edge sharpness characteristics within the criteria established by the upper trace of a coating produced with a mask and air pressure control system of the present invention. None of the oversprayed droplets exceed 100 μm Feret diameter. The valley-to-peak distance of the coating edge was also below 100 μm. In addition, the region of oversprayed droplets beyond the coating edge was less than 1.5 mm.

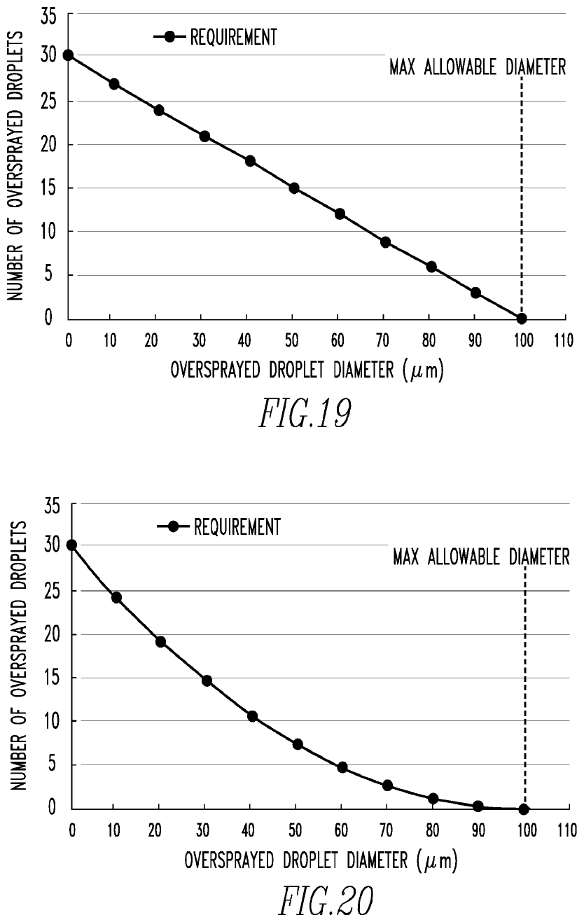

The size distribution of the oversprayed droplets may be below other selected distribution curves. Exemplary distribution curves may be in a linear or parabolic form as shown in FIGS. 19 and 20, or may be empirically derived such as described above and shown in FIG. 18. In addition, the maximum allowable Feret diameter of oversprayed droplets may be 100 μm, and the region of oversprayed droplets beyond the coating edge may not exceed 1.5 mm.

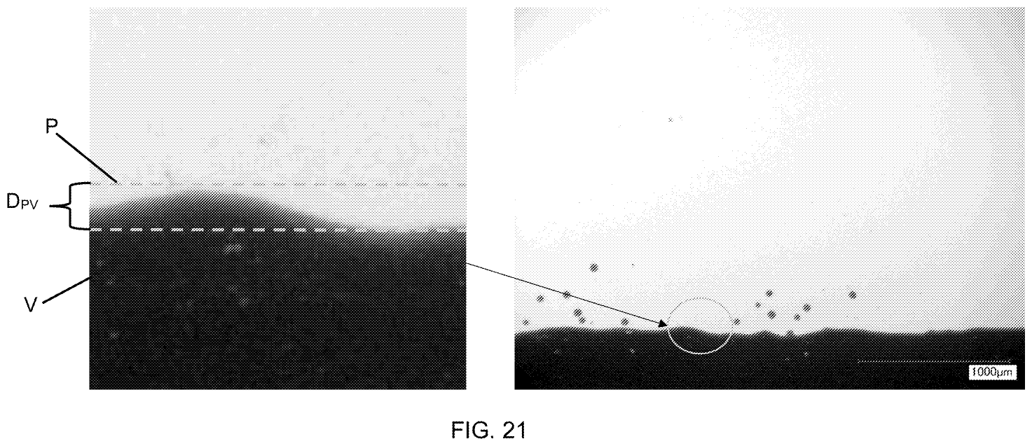

FIG. 21 includes a magnified portion of the coating edge shown in FIG. 17. The distance between a peak P and adjacent valley V is labeled D_{PV}. The peak-to-valley distance D_{PV} on a printed edge may not exceed, for example, 100 μm.

The following Aspects are provided.

Aspect 1. A method for controlling liquid coating droplets during deposition onto a substrate, the method comprising:
directing atomized liquid coating droplets in a flow path toward the substrate; and
applying a vacuum or pressurized air to at least a portion of the atomized liquid coating droplets in the flow path.

Aspect 2. The method of Aspect 1, wherein a vacuum is applied to the atomized liquid coating droplets in the flow path.

Aspect 3. The method of any of Aspects 1 or 2, wherein the vacuum removes a portion of the atomized liquid coating droplets from the flow path to prevent the removed atomized liquid coating droplets from being deposited on the substrate.

Aspect 4. The method of any of Aspect 1-3, wherein the atomized liquid coating droplets in the flow path comprise a distribution of different droplet particle sizes and the vacuum removes at least a portion of smaller sized droplets from the flow path to prevent the removed smaller sized droplets from being deposited on the substrate.

Aspect 5. The method of any of Aspects 1-4, wherein the flow path of atomized liquid coating droplets passes through a nozzle opening of an air pressure control mask, and the vacuum is applied adjacent to the nozzle opening.

Aspect 6. The method of Aspect 1, wherein pressurized air is applied to the atomized liquid coating droplets in the flow path.

Aspect 7. The method of any of Aspects 1-6, further comprising evaluating edge sharpness of the coating droplets deposited on the substrate by determining a number of oversprayed droplets deposited outside an intended edge of the coating, measuring diameters of the oversprayed droplets, and comparing the numbers and diameters of the oversprayed droplets against predetermined droplet number and diameter criteria to determine whether the oversprayed droplets meet the predetermined droplet number and diameter criteria to provide an acceptable edge sharpness.

Aspect 8. An air pressure control mask for depositing liquid coating droplets on a substrate to produce a coating, the air pressure control mask comprising:
an air pressure control fixture structured and arranged for connection to a source of vacuum or pressurized air; and
a nozzle opening structured and arranged to at least partially surround a flow path of the liquid coating droplets and to selectively allow at least a portion of the liquid coating droplets to pass through the air pressure control mask,
wherein the vacuum or pressurized air prevents at least a portion of oversprayed liquid coating droplets from being deposited on the substrate outside an intended edge of the coating.

Aspect 9. The air pressure control mask of Aspect 8, further comprising a coating droplet ejector structured and arranged to generate the flow path of the liquid coating droplets.

Aspect 10. The air pressure control mask of any of Aspects 1-9, wherein the at least one air pressure port comprises a vacuum port that draws a vacuum to decrease pressure in the flow path to thereby remove a portion of the droplets from the flow path.

Aspect 11. The air pressure control mask of Aspect 10, comprising at least two of the vacuum ports located on opposite sides of the nozzle opening.

Aspect 12. The air pressure control mask of any of Aspects 10 and 11, comprising at least four of the vacuum ports located at 90° intervals around a periphery of the nozzle opening.

Aspect 13. The air pressure control mask of any of Aspects 8-12, wherein the nozzle opening is substantially square.

Aspect 14. The air pressure control mask of any of Aspects 8-12, wherein the nozzle opening is substantially circular.

Aspect 15. The air pressure control mask of any of Aspects 8-12, wherein the nozzle opening is substantially triangular.

Aspect 16. The air pressure control mask of any of Aspect 8-15, comprising a plurality of vacuum ports surrounding the nozzle opening in flow communication with the vacuum source.

Aspect 17. The air pressure control mask of any of Aspects 8-16, wherein the nozzle opening is substantially square and comprises a first set of opposing peripheral edges and a second set of opposing peripheral edges, and at least one of the vacuum ports is located at each of the peripheral edges.

Aspect 18. The air pressure control mask of any of Aspects 8-17, further comprising a separate vacuum supply line in flow communication with each of the vacuum ports located at each of the peripheral edges.

Aspect 19. The air pressure control mask of any of Aspect 8-18, wherein the nozzle opening comprises opposing movable sidewalls arranged at angles with respect to a primary flow direction of the flow path, and the angles are adjustable.

Aspect 20. The air pressure control mask of any of Aspects 8-19, further comprising a retractable shutter structured and arranged to selectively open and close the nozzle opening.

For purposes of the description above, it is to be understood that the invention may assume various alternative variations and step sequences except where expressly specified to the contrary. Moreover, other than in any operating examples, or where otherwise indicated, all numbers expressing, for example, quantities of ingredients used in the specification and claims, are to be understood as being modified in all instances by the term “about”. Accordingly, unless indicated to the contrary, the numerical parameters set forth are approximations that may vary depending upon the desired properties to be obtained by the present invention. At the very least, and not as an attempt to limit the application of the doctrine of equivalents, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application, the articles “a,” “an,” and “the” include plural referents unless expressly and unequivocally limited to one referent.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

Whereas particular embodiments of this invention have been described above for purposes of illustration, it will be evident to those skilled in the art that numerous variations of the details of the present invention may be made without departing from the invention as defined in the appended claims.

What is claimed is:

1. A method for controlling liquid coating droplets during deposition onto a substrate, the method comprising:
directing atomized liquid coating droplets in a flow path toward the substrate; and
applying a vacuum or pressurized air to at least a portion of the atomized liquid coating droplets in the flow path.

2. The method of claim 1, wherein a vacuum is applied to the atomized liquid coating droplets in the flow path.

3. The method of claim 2, wherein the vacuum removes a portion of the atomized liquid coating droplets from the flow path to prevent the removed atomized liquid coating droplets from being deposited on the substrate.

4. The method of claim 2, wherein the atomized liquid coating droplets in the flow path comprise a distribution of different droplet particle sizes and the vacuum removes at least a portion of smaller sized droplets from the flow path to prevent the removed smaller sized droplets from being deposited on the substrate.

5. The method of claim 2, wherein the flow path of atomized liquid coating droplets passes through a nozzle opening of an air pressure control mask, and the vacuum is applied adjacent to the nozzle opening.

6. The method of claim 1, wherein pressurized air is applied to the atomized liquid coating droplets in the flow path.

7. The method of claim 1, further comprising evaluating edge sharpness of the coating droplets deposited on the substrate by determining a number of oversprayed droplets deposited outside an intended edge of the coating, measuring diameters of the oversprayed droplets, and comparing the numbers and diameters of the oversprayed droplets against predetermined droplet number and diameter criteria to determine whether the oversprayed droplets meet the predetermined droplet number and diameter criteria to provide an acceptable edge sharpness.

8. An air pressure control mask for depositing liquid coating droplets on a substrate to produce a coating, the air pressure control mask comprising:
an air pressure control fixture structured and arranged for connection to a source of vacuum or pressurized air; and
a nozzle opening structured and arranged to at least partially surround a flow path of the liquid coating droplets and to selectively allow at least a portion of the liquid coating droplets to pass through the air pressure control mask,
wherein the vacuum or pressurized air prevents at least a portion of oversprayed liquid coating droplets from being deposited on the substrate outside an intended edge of the coating.

9. The air pressure control mask of claim 8, further comprising a coating droplet ejector structured and arranged to generate the flow path of the liquid coating droplets.

10. The air pressure control mask of claim 8, wherein the at least one air pressure port comprises a vacuum port that draws a vacuum to decrease pressure in the flow path to thereby remove a portion of the droplets from the flow path.

11. The air pressure control mask of claim 10, comprising at least two of the vacuum ports located on opposite sides of the nozzle opening.

12. The air pressure control mask of claim 10, comprising at least four of the vacuum ports located at 90° intervals around a periphery of the nozzle opening.

13. The air pressure control mask of claim 8, wherein the nozzle opening is substantially square.

14. The air pressure control mask of claim 8, wherein the nozzle opening is substantially circular.

15. The air pressure control mask of claim 8, wherein the nozzle opening is substantially triangular.

16. The air pressure control mask of claim 8, comprising a plurality of vacuum ports surrounding the nozzle opening in flow communication with the vacuum source.

17. The air pressure control mask of claim 16, wherein the nozzle opening is substantially square and comprises a first set of opposing peripheral edges and a second set of opposing peripheral edges, and at least one of the vacuum ports is located at each of the peripheral edges.

18. The air pressure control mask of claim 16, further comprising a separate vacuum supply line in flow communication with each of the vacuum ports located at each of the peripheral edges.

19. The air pressure control mask of claim 8, wherein the nozzle opening comprises opposing movable sidewalls arranged at angles with respect to a primary flow direction of the flow path, and the angles are adjustable.

20. The air pressure control mask of claim 8, further comprising a retractable shutter structured and arranged to selectively open and close the nozzle opening.
